(19) United States
(12) Patent Application Publication
(10) Pub. No.: US 2008/0031007 A1
(43) Pub. Date: Feb. 7, 2008

(54) Housing for backlight module, backlight module and liquid crystal display device

(75) Inventors: Chia-Huang Wu, Tai Chung City (TW); Shih-Jung Lai, Feng Yuan City (TW); Ta-Ho Yang, Ho Mei Town (TW)

Correspondence Address: BIRCH STEWART KOLASCH & BIRCH, PO BOX 747, FALLS CHURCH, VA, 22040-0747, US

(73) Assignee: Wintek Corporation

(21) Appl. No.: 11/882,544

(22) Filed: Aug. 2, 2007

(30) Foreign Application Priority Data
Aug. 4, 2006 (TW) 095213709

(51) Int. Cl. F21V 8/00; G02F 1/13357

(52) U.S. Cl. 362/607; 349/58; 362/632

(57) ABSTRACT

A housing for a backlight module includes a bottom plate, a sidewall, at least one catch member, and at least two resilient protrusions. The sidewall is provided on the periphery of the bottom plate and has a step portion in which a lateral face is formed to at least partially surround the bottom plate. The catch member is provided on the sidewall and has a contact surface at its one end. The contact surface of the catch member has a height difference relative to the lateral face of the sidewall, and the resilient protrusions are formed on the lateral face of the sidewall and convex toward the contact surface of the catch member.

### BACKGROUND OF THE INVENTION

(a) Field of the Invention

The invention relates to a housing for a backlight module capable of eliminating sliding or other movement of optical sheets that are assembled to the housing.

(b) Description of the Related Art

FIG. 1 shows a cross-section of a conventional backlight module. Referring to FIG. 1, the backlight module 100 includes a plastic frame 102, a rigid frame 104 coupled to the plastic frame 102, a light guide plate 106, a light-emitting element 108, and a set of optical sheets 110. The middle part of the plastic frame 102 is laterally extended to the inside of the backlight module 100 to form a baffle portion 102a, and the top edge of the plastic frame 102 is also laterally extended to form a hook portion 102b. The set of optical sheets 110 may, for instance, includes a top brightness enhancement film 110a, a bottom brightness enhancement film 110b, and a diffuser film 110c.

According to the above design, a clearance fit must be provided between the hook portion 102b and the baffle portion 102a to facilitate the engagement between the set of optical sheets 110 and the plastic frame 102. In that case, a residue space, however, always exists after the optical sheets 110 are inserted into the plastic frame 102, so the optical sheets 110 are not firmly fixed in place and often slid above the light guide plate 106 to cause inferior positioning and an unfavorable phenomenon during operation like Newton's rings.

FIG. 2 shows a partial enlarged view of a housing for another conventional backlight module. According to this design, an elastic sheet 202 and a clasp structure 206 are provided to solve the aforesaid problem. Referring to FIG. 2, the elastic sheet 202 is provided at the same level with the top face 204a of the sidewall 204. When a stack of optical sheets (not shown) are inserted between the top face 204a of the sidewall 204 and a contact surface 206a of the clasp structure 206, the clasp structure 206 and the elastic sheet 202 may both press against the optical sheets to prevent them from sliding.

However, since the elastic sheet 202 must include a cantilever part 202a to support the optical sheets, the considerable occupied space of the cantilever part 202a may enlarge the volume and complicate the formation of a stamper for molding a housing with the elastic sheet 202 to thus increase the fabrication cost.

### BRIEF SUMMARY OF THE INVENTION

Hence, an object of the invention is to provide a housing for a backlight module capable of eliminating sliding or other movement of optical sheets that are assembled to the housing.

According to an aspect of the invention, a housing for a backlight module includes a bottom plate, a sidewall, at least one catch member, and at least two resilient protrusions. The sidewall is provided on the periphery of the bottom plate and has a step portion in which a lateral face is formed to at least partially surround the bottom plate. The catch member is provided on the sidewall and has a contact surface at its one end. The contact surface of the catch member has a height difference relative to the lateral face of the sidewall, and the resilient protrusions are formed on the lateral face of the sidewall and convex toward the contact surface of the catch member.

According to another aspect of the invention, a backlight module includes a housing, a light-emitting element, a light guide plate, a plurality of optical sheets, and at least two resilient protrusions. The housing includes a sidewall and at least one catch member attached on the sidewall. The sidewall is formed as a closed loop to define an accommodation space and has a step portion in which a lateral face is formed, and the catch member has a contact surface at its one end, with the contact surface being higher than and substantially in parallel with the lateral face of the sidewall. The light-emitting element and light guide plate are received in the accommodation space, and a plurality of optical sheets are inserted between the lateral face of the sidewall and the contact surface of the catch member. The resilient protrusions are formed on the lateral face of the sidewall and convex toward the contact surface of the catch member. When the optical sheets are inserted between the lateral face of the sidewall and the contact surface of the catch member, the bottom of the optical sheets presses against the resilient protrusions.

Through the design of the invention, since the optical sheets inserted between the catch member and the sidewall are pressed against the resilient protrusion due to its resilient force, they are firmly held in place without sliding or other movement. More specifically, since the resilient protrusion is elastic and thus deforms as being applied with external force, a clearance fit is no longer provided when the optical sheets are assembled to the housing to effectively eliminate the residue space in the assembly and the sliding or other movement of the optical sheets as a result. Thus, the simple design of the resilient protrusion that occupies only a small space may minimize and simplify the formation of the stamper for molding the housing to reduce the fabrication cost.

### BRIEF DESCRIPTION OF THE DRAWINGS

FIG. 1 shows a cross-section of a conventional backlight module.

FIG. 2 shows a partial enlarged view of a housing for another conventional backlight module.

FIG. 3 shows a three-dimensional view illustrating a housing for a backlight module according to an embodiment of the invention, and

FIG. 4 shows a partial enlarged view M of FIG. 3.

FIGS. 5A to 5D show schematic cross-sections of the housing under different conditions where the optical sheets of a backlight module are or are not put into the housing.

FIG. 6 shows a cross-section illustrating another embodiment of the invention.

FIGS. 7A to 7C show schematic diagrams illustrating different distributions of resilient protrusions on the lateral face of a step portion of the housing.

FIGS. 8A to 8D show schematic diagrams illustrating different shapes of resilient protrusions.

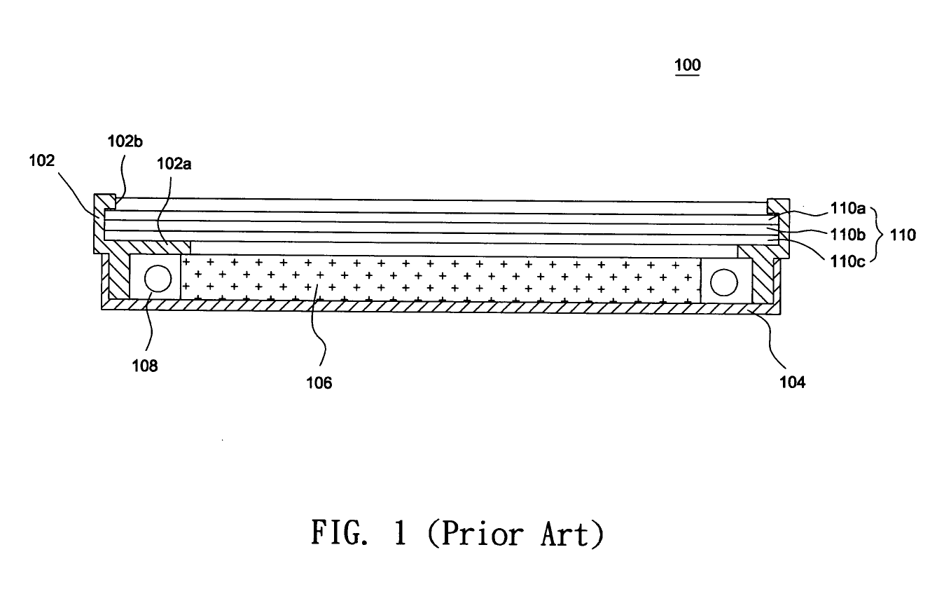

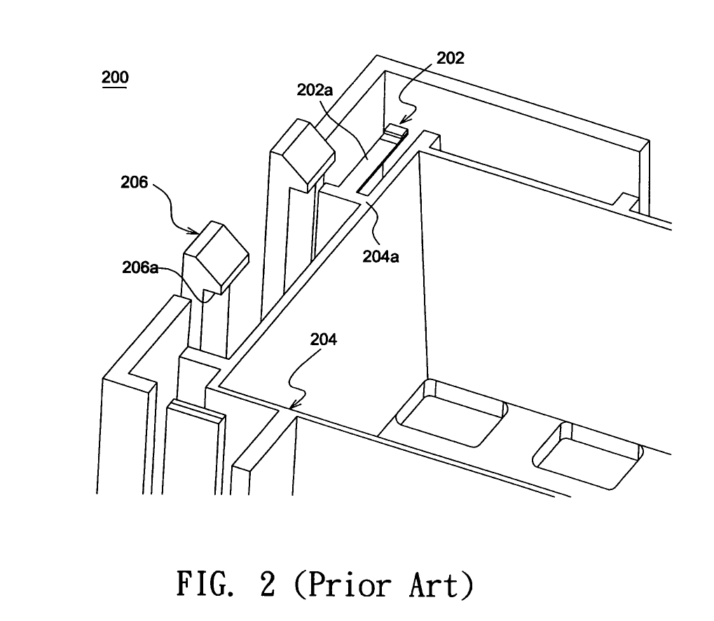

### DETAILED DESCRIPTION OF THE INVENTION

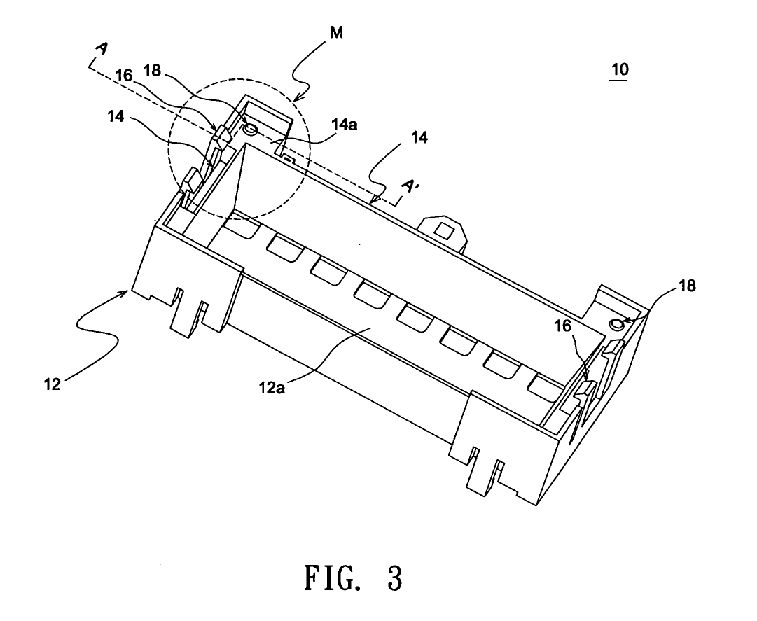

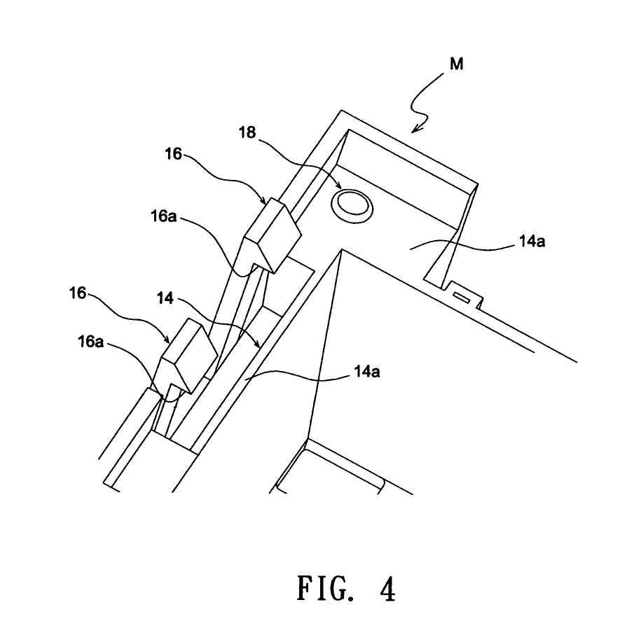

FIG. 3 shows a three-dimensional view illustrating a housing 10 for a backlight module according to an embodiment of the invention, and FIG. 4 shows a partial enlarged view M of FIG. 3.

Referring to FIG. 3, the housing 10 includes a frame 12, at least one catch member 16, and at least two resilient protrusions 18 formed on the frame 12. The frame 12 includes a bottom plate 12a and a sidewall 14 provided in the periphery of the bottom plate 12a. The sidewall 14 is formed as a closed loop and together with the bottom plate 12a to define an accommodation space. Further, the sidewall 14 has a step portion in which a top lateral face 14a is formed to at least partially surround the bottom plate 12a.

The catch member 16 is provided on the frame 12, and, in this embodiment, there are four catch member 16 arranged on two opposite sides of the sidewall 14, as shown in FIG. 3. Referring to FIG. 4, one end of the catch member 16 is formed as a hook portion having a contact surface 16a that has a height difference relative to and is in parallel with the lateral face 14a of the sidewall 14. Thus, the contact surface 16a of the catch member 16 and the lateral face 14a of the sidewall 14 altogether function as an engagement mechanism to firmly hold a set of optical sheets when they are put into the housing 10.

The resilient protrusions 18 are formed on the lateral face 14a of a step portion of the sidewall 14 and convex toward the contact surface 16a of the catch member 16. The number of the resilient protrusions 18 is preferably no less than two, and, in this embodiment, there are four resilient protrusions 18 situated in all the four corners of the sidewall 14. Also, the resilient protrusions 18 and the sidewall 14 may be integrated formed as one piece by plastic injection molding; alternatively, each resilient protrusion 18 may be formed as a separate piece and then attached on the lateral face 14a of the sidewall 14. Further, each resilient protrusion 18 is preferably formed as a thin shell structure having an empty space inside.

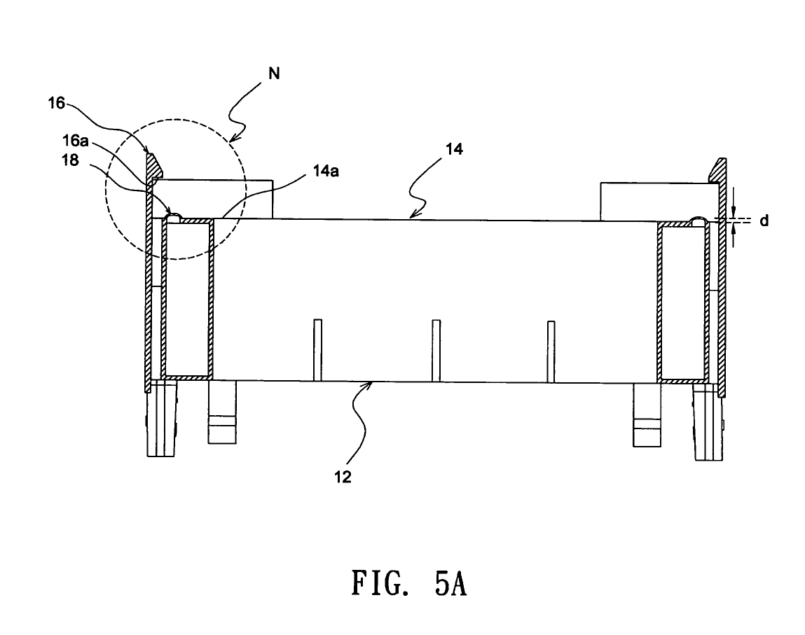

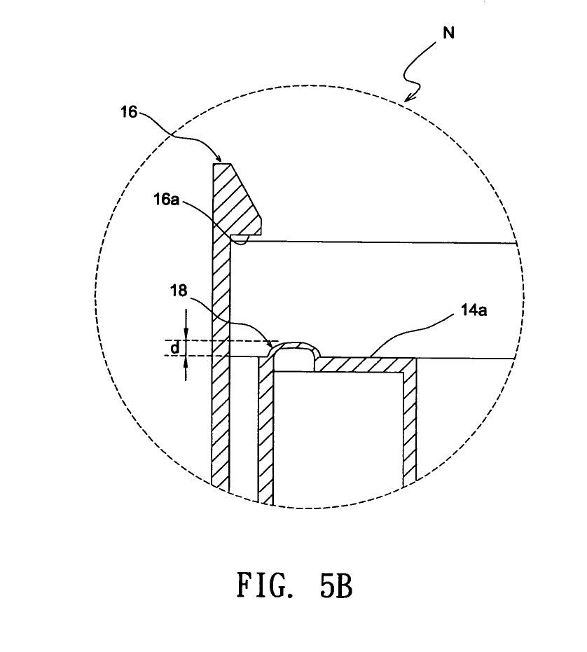

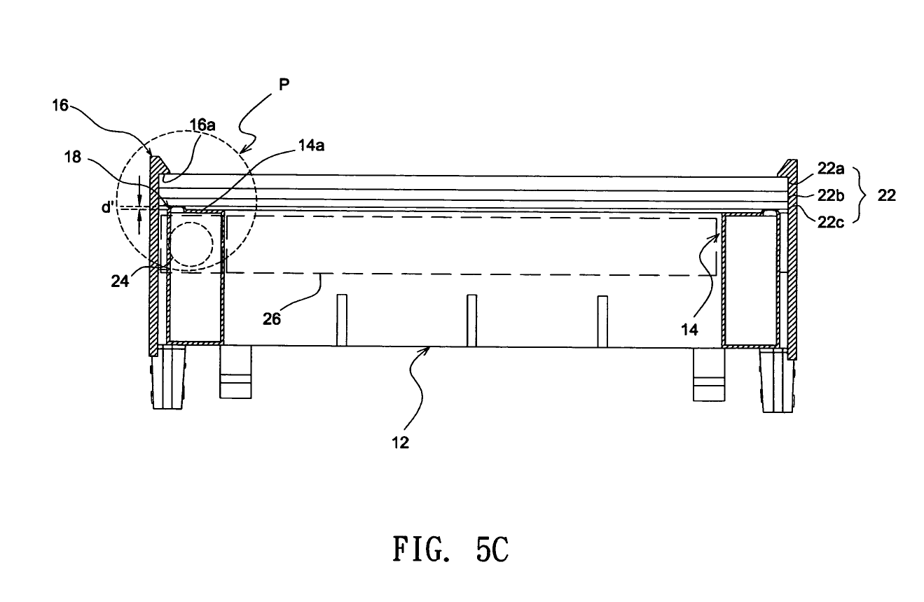

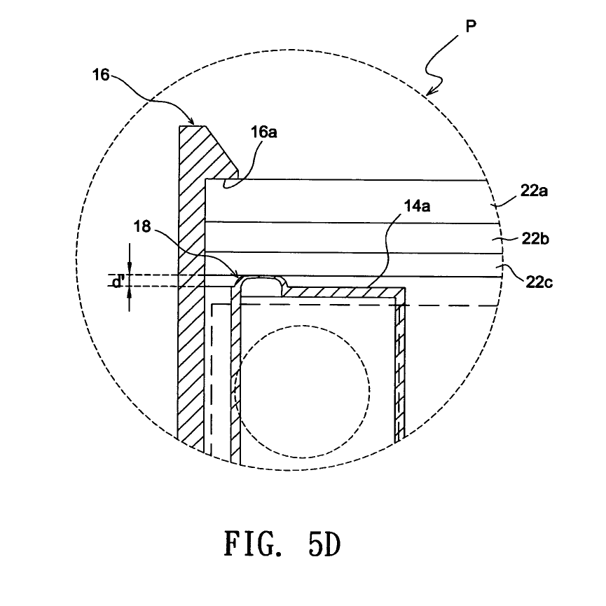

FIGS. 5A to 5D show schematic cross-sections of the housing 10 under different conditions where the optical sheets of a backlight module are or are not put into the housing. FIG. 5A shows a cross-section cut along line A-A′ in FIG. 3 where the optical sheets are not put into the housing 10, and FIG. 5B shows a partial enlarged view N of FIG. 5A. In comparison, FIG. 5C shows a schematic cross-section of the housing 10 where the optical sheets are put into the housing 10, and FIG. 5D shows a partial enlarged view P of FIG. 5C. In case the optical sheets are not put into the housing 10 between the contact surface 16a of the catch member 16 and the lateral face 14a of the sidewall 14, the resilient protrusions 18 are naturally convex and have a projected thickness d relative to the lateral face 14a, as shown in FIGS. 5A and 5B.

Referring to FIGS. 5C and 5D, when a stack of optical sheets 22, such as a liquid crystal display (LCD) panel 22a, a brightness enhancement film 22b, and a diffuser film 22c, are inserted between the contact surface 16a of the catch member 16 and the lateral face 14a of the sidewall 14, the bottom of the stack of optical sheets 22 (the bottom side of the diffuser film 22c in this embodiment) presses against the resilient protrusion 18, and meanwhile the contact surface 16a of the catch member 16 presses against the top of the stack of optical sheets 22 (the top side of the LCD panel 22a in this embodiment). Accordingly, the optical sheets 22 are firmly held in the housing 10 to avoid sliding or other movement of the optical sheets 22. Also, as the bottom of the stack of optical sheets 22 presses against the resilient protrusion 18, the resilient protrusion 18 is compressed to have a reduced thickness d′, and the contact area between the resilient protrusion 18 and the diffuser film 22c is enlarged to further avoid sliding or other movement of the optical sheets 22.

Through the design of the invention, since the optical sheets 22 inserted between the catch member 16 and the sidewall 14 are pressed against the resilient protrusion 18 due to its resilient force, they are firmly held in place without sliding or other movement. More specifically, since the resilient protrusion 18 is elastic and thus deforms as being applied with external force, a clearance fit is no longer provided when the optical sheets 22 are assembled to the housing 10 to effectively eliminate the residue space in the assembly and the sliding or other movement of the optical sheets 22 as a result. Thus, the simple design of the resilient protrusion 18 that occupies only a small space may minimize and simplify the formation of the stamper for molding the housing 10 to reduce the fabrication cost.

Moreover, as shown in FIG. 5C, a light-emitting element 24 such as a light-emitting diode and a light guide plate 26 are received in the accommodation space defined by the sidewall 14. Further, the stack of optical sheets 22 includes, but is not limited to, the LCD panel 22a, the brightness enhancement film 22b, and the diffuser film 22c. Other kinds of optical sheets may also be firmly held in the housing 10 as they are pressed against the resilient protrusions 18. Besides, the overall thickness of the stack of optical sheets 22 is preferably equal to or slightly smaller than the height between the contact surface 16a of the catch member 16 and the lateral face 14a of the sidewall 14.

In addition, the catch member 16 is not limited to a clasp structure shown in FIG. 4, as long as it may provide an engaging part to cooperate with the resilient protrusions 18 on the sidewall 14 to hold the optical sheets 22 in place. For example, the catch member 16 may be a cap structure or other member capable of pressing against an object.

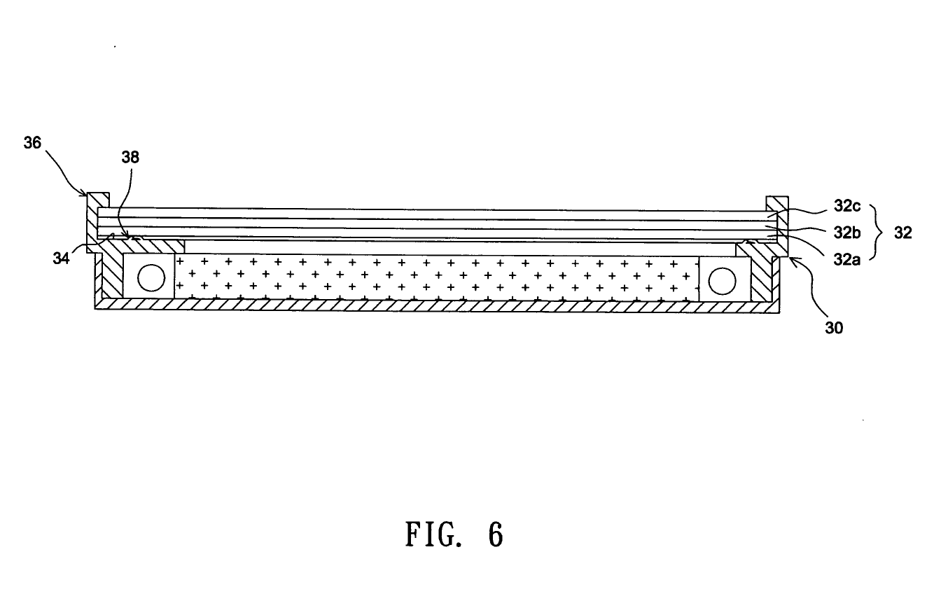

FIG. 6 shows a cross-section illustrating another embodiment of the invention. Referring to FIG. 6, each top edge of a housing 30 is laterally extended to form a hook portion 36, and resilient protrusions 38 are formed on the lateral face 34 of a step portion of the housing 30. Further, in this embodiment, a stack of optical sheets 32 that includes a diffuser film 32a, a first brightness enhancement film 32b, and a second brightness enhancement film 32c is inserted between the hook portions 36 and the resilient protrusions 38. The optical sheets 32 and the housing 30 altogether form a backlight module, which is assembled with an LCD panel to form a liquid crystal display device.

Further, the shape of the top lateral face 14a of the sidewall 14 is not limited to a rectangular loop shown in FIG. 3, and its shape and area can be arbitrary selected according the actual demand.

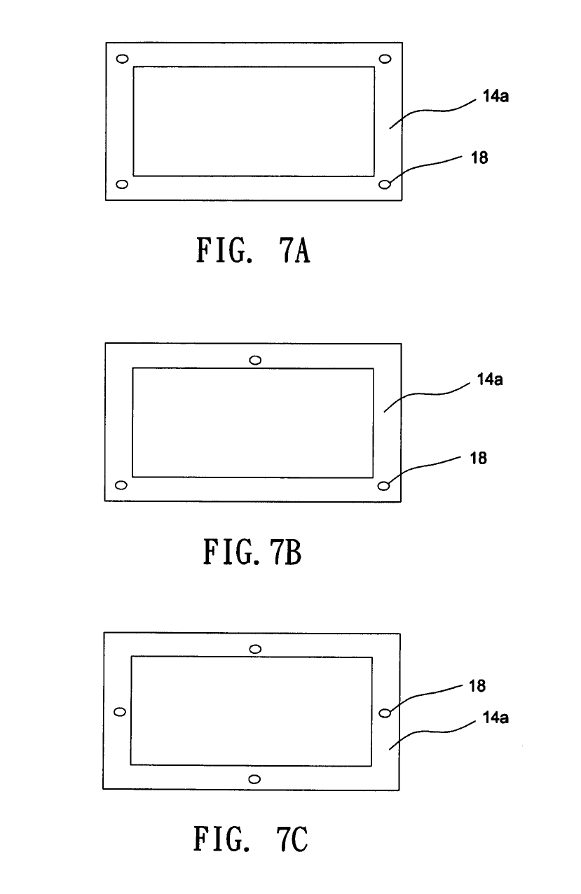

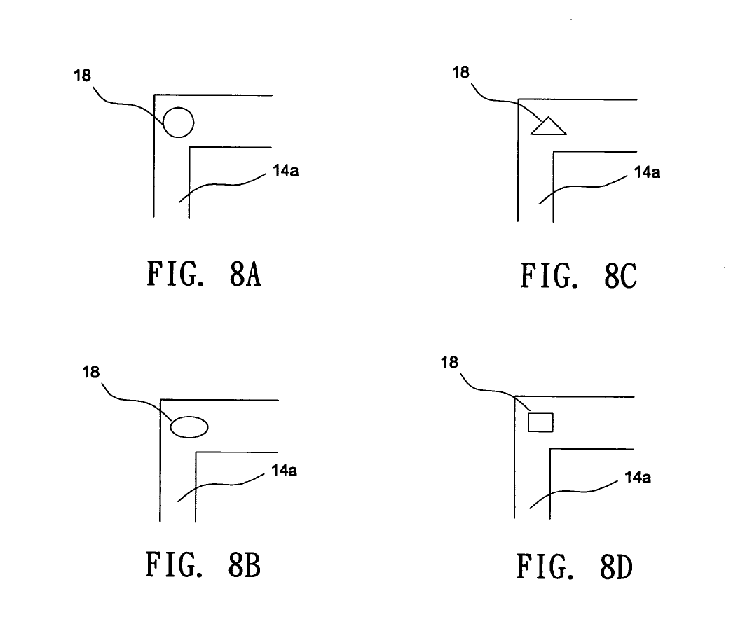

FIGS. 7A to 7C show schematic diagrams illustrating different distributions of resilient protrusions 18 on the lateral face 14a of a step portion of the housing. The number and position of the resilient protrusions 18 can be arbitrary selected according the actual demand; for example, they may disperse on all the four corners of the sidewall 14 (FIG. 7A), arranged on the lateral face 14a in a shape of a triangle (FIG. 7B), or dispersed on the lateral face 14a in symmetry such as in a shape of a cross (FIG. 7C). Preferably, the protrusion 18 may have a cross-section of a circle (FIG. 8A) or an ellipse (FIG. 8B), but this is not limited. It may also have a cross-section of a polygon such as a triangle (FIG. 8C) or a rectangle (FIG. 8D).

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A housing for a backlight module, comprising:
a bottom plate;
a sidewall provided on the periphery of the bottom plate, the sidewall having a step portion in which a lateral face is formed to at least partially surround the bottom plate;
at least one catch member provided on the sidewall, the catch member having a contact surface at its one end, with the contact surface having a height difference relative to the lateral face of the sidewall; and
at least two resilient protrusions formed on the lateral face of the sidewall and convex toward the contact surface of the catch member.

2. The housing as claimed in claim 1, wherein the lateral face of the sidewall is substantially in parallel with the contact surface of the catch member.

3. The housing as claimed in claim 1, wherein the backlight module includes a stack of optical sheets, and the stack of optical sheets are inserted between the lateral face of the sidewall and the contact surface of the catch member.

4. The housing as claimed in claim 3, wherein the stack of optical sheets comprises at least one brightness enhancement film and at least one diffuser film.

5. The housing as claimed in claim 3, wherein the overall thickness of the stack of optical sheets is equal to or slightly smaller than the height between the lateral face of the sidewall and the contact surface of the catch member.

6. The housing as claimed in claim 1, wherein the resilient protrusions and the sidewall are integrally formed as one piece.

7. The housing as claimed in claim 1, wherein each resilient protrusion is formed as a thin shell structure having an empty space inside.

8. The housing as claimed in claim 1, wherein the catch member is formed as a clasp structure or a cap structure.

9. The housing as claimed in claim 1, wherein the lateral face of the sidewall has a shape of a rectangular loop.

10. The housing as claimed in claim 9, wherein the resilient protrusions are dispersed on the rectangular loop in symmetry.

11. The housing as claimed in claim 9, wherein the resilient protrusions are dispersed on all the four corners of the sidewall.

12. The housing as claimed in claim 1, wherein each resilient protrusion has a cross-section of a circle, an ellipse, or a polygon.

13. A backlight module, comprising:
a housing comprising a sidewall and at least one catch member attached on the sidewall, the sidewall being formed as a closed loop to define an accommodation space and having a step portion in which a lateral face is formed, and the catch member having a contact surface at its one end, with the contact surface of the catch member being higher than and substantially in parallel with the lateral face of the sidewall;
a light-emitting element and a light guide plate received in the accommodation space;
a plurality of optical sheets inserted between the lateral face of the sidewall and the contact surface of the catch member; and
at least two resilient protrusions formed on the lateral face of the sidewall and convex toward the contact surface of the catch member;
wherein the bottom of the optical sheets presses against the resilient protrusions when the optical sheets are inserted between the lateral face of the sidewall and the contact surface of the catch member.

14. The backlight module as claimed in claim 13, wherein the resilient protrusions and the sidewall are integrally formed as one piece.

15. The backlight module as claimed in claim 13, wherein each resilient protrusion is formed as a thin shell structure having an empty space inside.

16. The backlight module as claimed in claim 13, wherein the catch member is formed as a clasp structure or a cap structure.

17. The backlight module as claimed in claim 13, wherein the resilient protrusions are dispersed on the closed loop in symmetry.

18. The backlight module as claimed in claim 13, wherein the resilient protrusions are dispersed on all the four corners of the sidewall.

19. The backlight module as claimed in claim 13, wherein each resilient protrusion has a cross-section of a circle, an ellipse, or a polygon.

20. A liquid crystal display device, comprising:
a housing comprising a sidewall and at least one catch member attached on the sidewall, the sidewall having a step portion in which a lateral face is formed as a closed loop to define an accommodation space, and the catch member having a contact surface at its one end, with the contact surface being higher than and substantially in parallel with the lateral face of the sidewall;
a light-emitting element and a light guide plate received in the accommodation space;
at least one diffuser, at least one brightness enhancement film, and a liquid crystal display panel inserted between the lateral face of the sidewall and the contact surface of the catch member; and
at least two resilient protrusions formed on the lateral face of the sidewall and convex toward the contact surface of the catch member.
